(19) United States
(12) Patent Application Publication
(10) Pub. No.: US 2026/0245237 A1
(43) Pub. Date: Aug. 20, 2026

(54) TRAINING APPARATUS, TRAINING METHOD, AND NON-TRANSITORY COMPUTER-READABLE STORAGE MEDIUM

(71) Applicant: NEC CORPORATION, Mirato-ku, Tokyo (JP)

(72) Inventors: Royston RODRIGUES, Singapore (SG); Masahiro TANI, Tokyo (JP)

(73) Assignee: NEC CORPORATION, Mirato-ku, Tokyo (JP)

(21) Appl. No.: 18/995,232

(22) PCT Filed: Aug. 25, 2022
(86) PCT No.: PCT/JP2022/032013

§ 371 Date: Jan. 16, 2025

(51) Int. Cl. G06T 7/73; G06V 10/82; G06V 20/17

(52) U.S. Cl. CPC G06T 7/73; G06V 10/82; G06V 20/17; G06T 2207/10032; G06T 2207/20081; G06T 2207/20084

(57) ABSTRACT

A training apparatus acquires a training data that includes a ground captured image, an aerial captured image, and a map image. The training apparatus inputs the ground captured image, the aerial captured image, and the map image into a first feature extractor, a second feature extractor, and a third feature extractor, respectively, thereby obtaining features of the ground captured image, features of the aerial captured image, and features of the map image. The training apparatus computes a combined loss based on the obtained features, and update the first feature extractor, the second feature extractor, and the third feature extractor based on the combined loss.

### TECHNICAL FIELD

The present disclosure generally relates to training apparatus, training method, and non-transitory computer-readable storage medium.

### BACKGROUND ART

A computer system that performs cross-view image localization has been developed. For example, NPL1 discloses a system comprising a set of feature extractors, which are implemented with CNN (Convolutional Neural Networks), to match a ground-level image against a satellite image to determine a place at which the ground-level image is captured. Specifically, one of the feature extractors is configured to acquires a set of a ground-level image and orientation maps that indicate orientations (azimuth and altitude) for each location captured in the ground-level image, and is trained to extract features therefrom. The other one is configured to acquire a set of a satellite image and orientation maps that indicate orientations (azimuth and range) for each location captured in the satellite image, and is trained to extract features therefrom. Then, the system determines whether the ground-level image matches the satellite image based on the features that are extracted by the trained feature extractors.

### CITATION LIST

### Patent Literature

PTL1: International Patent Publication No. WO2022/034678
PTL2: International Patent Publication No. WO2022/044105

### Non Patent Literature

NPL1: Liu Liu and Hongdong Li, “Lending Orientation to Neural Networks for Cross-view Geo-localization”, [online], Mar. 29, 2019, [retrieved on 2022 Aug. 17], retrieved from <arXiv, https://arxiv.org/pdf/1903.12351.pdf>

### SUMMARY OF INVENTION

### Technical Problem

In NPL1, it is not considered to use images other than images captured by cameras or their orientation maps to train the feature extractors. An objective of the present disclosure is to provide a novel technique to train feature extractors.

### Solution to Problem

The present disclosure provides a training apparatus that comprises at least one memory that is configured to store instructions and at least one processor.

The at least one processor is configured to execute the instructions to: acquire a training data including a first ground captured image, a first aerial captured image, and a first map image; input the first ground captured image to a first feature extractor to extract features of the first ground captured image; input the first aerial captured image to a second feature extractor to extract features of the first aerial captured image; input the first map image to a third feature extractor to extract features of the first map image; compute a combined loss based on the features of the first ground captured image, the features of the first aerial captured image, and the features of the first map image; and update the first feature extractor, the second feature extractor, and the third feature extractor based on the combined loss.

The present disclosure further provides a training method that comprises: acquiring a training data including a first ground captured image, a first aerial captured image, and a first map image; inputting the first ground captured image to a first feature extractor to extract features of the first ground captured image; inputting the first aerial captured image to a second feature extractor to extract features of the first aerial captured image; inputting the first map image to a third feature extractor to extract features of the first map image; computing a combined loss based on the features of the first ground captured image, the features of the first aerial captured image, and the features of the first map image; and updating the first feature extractor, the second feature extractor, and the third feature extractor based on the combined loss.

The present disclosure further provides a non-transitory computer readable storage medium storing a program. The program that causes a computer to execute: acquiring a training data including a first ground captured image, a first aerial captured image, and a first map image; inputting the first ground captured image to a first feature extractor to extract features of the first ground captured image; inputting the first aerial captured image to a second feature extractor to extract features of the first aerial captured image; inputting the first map image to a third feature extractor to extract features of the first map image; computing a combined loss based on the features of the first ground captured image, the features of the first aerial captured image, and the features of the first map image; and updating the first feature extractor, the second feature extractor, and the third feature extractor based on the combined loss.

### Advantageous Effects of Invention

According to the present disclosure, it is possible to provide a novel technique to train feature extractors.

### BRIEF DESCRIPTION OF DRAWINGS

FIG. 1 illustrates an overview of an training apparatus of the first example embodiment.

FIG. 2 illustrates an example of the training data.

FIG. 3 is a block diagram showing an example of the functional configuration of the training apparatus of the first example embodiment.

FIG. 4 is a block diagram illustrating an example of the hardware configuration of a computer realizing the training apparatus of the first example embodiment.

FIG. 5 shows a flowchart illustrating an example flow of process performed by the training apparatus of the first example embodiment.

FIG. 6 illustrates a geo-localization system in which a whole or a part of the feature extractor set is employed.

FIG. 7 illustrates an example way of computing the similarity score.

FIG. 8 illustrates an example way of computing the similarity score.

FIG. 9 illustrates an example way of computing the similarity score.

FIG. 10 illustrates an overview of a training apparatus of the second example embodiment.

FIG. 11 illustrates an example of data augmentation performed by the training apparatus.

FIG. 12 is a block diagram showing an example of the functional configuration of the training apparatus of the second example embodiment.

FIG. 13 shows a flowchart illustrating an example flow of process performed by the training apparatus of the second example embodiment.

FIG. 14 illustrates a case where a part of the map image is replaced with its counterpart of the aerial captured image.

FIG. 15 illustrates a case where a part of the aerial captured image is replaced with its counterpart of the map image.

### DESCRIPTION OF EMBODIMENTS

Example embodiments according to the present disclosure will be described hereinafter with reference to the drawings. The same numeral signs are assigned to the same elements throughout the drawings, and redundant explanations are omitted as necessary. In addition, predetermined information (e.g., a predetermined value or a predetermined threshold) is stored in advance in a storage unit to which a computer using that information has access unless otherwise described. In the present disclosure, a storage unit may be implemented with one or more storage devices, such as hard disks, solid-state drives (SSDs), or random-access memories (RAMs).

### First Example Embodiment

### Overview

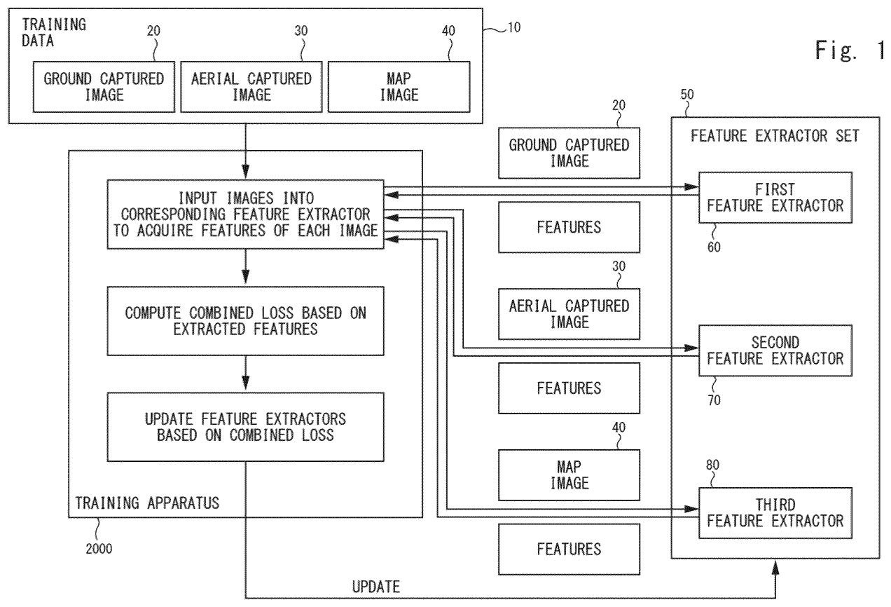

FIG. 1 illustrates an overview of a training apparatus 2000 of the first example embodiment. It is noted that FIG. 1 does not limit operations of the training apparatus 2000, but merely show an example of possible operations of the training apparatus 2000.

The training apparatus 2000 is an apparatus that is configured to acquire a training data 10 and to perform training on a feature extractor set 50 using the training data 10. The training data 10 includes a ground captured image 20, an aerial captured image 30, and a map image 40. The feature extractor set 50 includes three feature extractors: a first feature extractor 60, a second feature extractor 70, and a third feature extractor 80.

The first feature extractor 60 is configured to take the ground captured image 20 as input and to extract features from the ground captured image 20 input thereinto. The second feature extractor 70 is configured to take the aerial captured image 30 as input and to extract features from the aerial captured image 30 input thereinto. The third feature extractor 80 is configured to take the map image 40 as input and to extract features from the map image 40 input thereinto.

There are various possible forms of feature extractors, and one of those forms may be applied to the first feature extractor 60, the second feature extractor 70, and the third feature extractor 80. For example, the first feature extractor 60, the second feature extractor 70, and the third feature extractor 80 may be realized as machine learning-based models, such as neural networks. It is noted that it is possible that the first feature extractor 60, the second feature extractor 70, and the third feature extractor 80 are realized in different forms as each other.

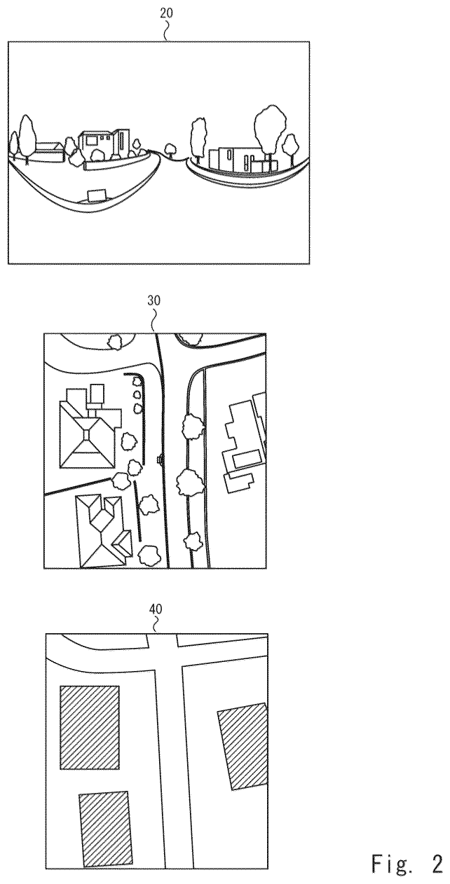

FIG. 2 illustrates an example of the training data 10. The ground captured image 20 is a digital image (e.g., an RGB image or gray-scale image) that includes a ground view of a place. The ground captured image 20 is generated by a camera, called “ground-view camera”, that captures the ground view of a place. The ground camera may be held by a pedestrian or installed in a vehicle, such as a car, a motorcycle, or a drone. The ground captured image 20 may be panoramic (having 360-degree field of view), or may have limited (less than 360-degree) field of view.

The aerial captured image 30 is a digital image (e.g., an RGB image or gray-scale image) that includes an aerial view (or a top view) of a place. The aerial captured image 30 may be generated by a camera, called aerial camera, that is installed in a drone, an air plane, a satellite, etc. in a manner that the aerial camera captures scenery in top view.

The map image 40 is a digital image (e.g., an RGB image or gray-scale image) that includes a map of a place. The map image 40 may be acquired from open data, such as OpenStreetMap (registered trade mark), or may be prepared by a provider, a user, or the like of the training apparatus 2000.

The aerial captured image 30 and the map image 40 in a training data 10 correspond to the same location as each other. For example, the center location of a place shown by the aerial captured image 30 and the center location of a place shown by the map image 40 are substantially close to each other so that the aerial captured image 30 and the map image 40 can be associated with the same location information as each other. The location information is information that identifies a location, such as GPS (Global Positioning System) coordinates.

The training apparatus 2000 may train the feature extractor set 50 as follows. The training apparatus 2000 inputs the ground captured image 20 into the first feature extractor 60, thereby obtaining the features of the ground captured image 20 from the first feature extractor 60. Similarly, the training apparatus 2000 inputs the aerial captured image 30 into the second feature extractor 70, thereby obtaining the features of the aerial captured image 30 from the second feature extractor 70. Furthermore, the training apparatus 2000 inputs the map image 40 into the third feature extractor 80, thereby obtaining the features of the map image 40 from the third feature extractor 80.

The training apparatus 2000 compute a combined loss based on the features of the ground captured image 20, those of the aerial captured image 30, and those of the map image 40. The combined loss may be computed by combining a loss between the features of the ground captured image 20 and those of the aerial captured image 30, a loss between the features of the ground captured image 20 and those of the map image 40, and a loss between the features of the aerial captured image 30 and those of the map image 40. Then, the training apparatus 2000 updates the feature extractor set 50 based on the combined loss. The feature extractor set 50 may be trained by updating it using a plurality of the training data 10.

### Example of Advantageous Effect

According to the training apparatus 2000 of the first example embodiment, the features of the ground captured image 20, those of the aerial captured image 30, and those of the map image 40 are used to compute the combined loss, and this combined loss is used to train a set of feature extractors, i.e., feature extractor set 50. Thus, a novel technique to train feature extractors are provided.

It is noted that, as explained in detail later, the feature extractor set 50 may be used for cross-view image matching. However, either the second feature extractor 70 or the third feature extractor 80 may not be used for the cross-view image matching.

Suppose that the third feature extractor 80 is not used for the cross-view image matching. In this case, it is technically possible to exclude the third feature extractor 80 from the feature extractor set 50 when training the feature extractor set 50. However, even in the case where the third feature extractor 80 is not used for the cross-view image matching, it is advantageous to use the third feature extractor 80 in the training of the feature extractor set 50. Specifically, since the map image 40 is simpler than the aerial captured image 30 (e.g., a building is depicted as a rectangle or the like), a loss computed based on the features of the map image 40 can accelerate a training of the first feature extractor 60 and the second feature extractor 70.

In addition, preparing both the second feature extractor 70 and the third feature extractor 80 enables to choose one or both of them according to a situation in which the cross-view image matching is performed. For example, since the aerial captured image 30 is more informative than the map image 40, the second feature extractor 70 may be preferably employed for the cross-view image matching as long as the aerial captured images 30 are available. However, there may be some situations where the aerial captured images 30 are not available due to, for example, regulations by an authority such as a national or local government. In those situations, the third feature extractor 80 is employed for the cross-view image matching.

Hereinafter, more detailed explanation of the training apparatus 2000 will be described.

### Example of Functional Configuration

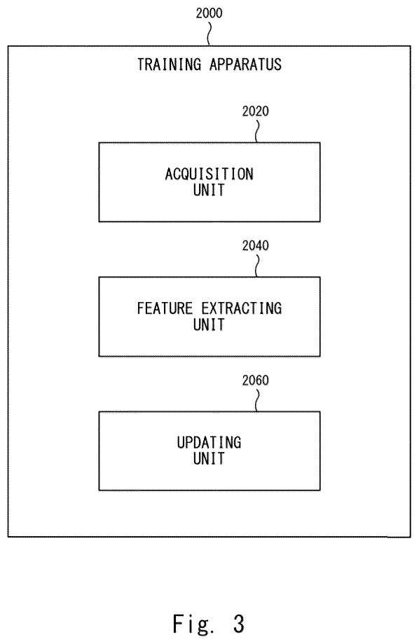

FIG. 3 is a block diagram showing an example of the functional configuration of the training apparatus 2000 of the first example embodiment. The training apparatus 2000 includes an acquiring unit 2020, a feature extracting unit 2040, and an updating unit 2060.

The acquiring unit 2020 acquires a training data 10 that includes the ground captured image 20, the aerial captured image 30, and the map image 40. The feature extracting unit 2040 inputs the ground captured image 20 into the first feature extractor 60 to acquire the features of the ground captured image 20 from the first feature extractor 60. The feature extracting unit 2040 inputs the aerial captured image 30 into the second feature extractor 70 to acquire the features of the aerial captured image 30 from the second feature extractor 70. The feature extracting unit 2040 inputs the map image 40 into the third feature extractor 80 to acquire the features of the map image 40 from the third feature extractor 80. The updating unit 2060 computes a combined loss based on the features of the ground captured image 20, those of the aerial captured image 30, and those of the map image 40. Then, the updating unit 2060 updates the feature extractor set 50 (i.e., the first feature extractor 60, the second feature extractor 70, and the third feature extractor 80) based on the combined loss.

### Example of Hardware Configuration

The training apparatus 2000 may be realized by one or more computers. Each of the one or more computers may be a special-purpose computer manufactured for implementing the training apparatus 2000, or may be a general-purpose computer like a personal computer (PC), a server machine, or a mobile device.

The training apparatus 2000 may be realized by installing an application in the computer. The application is implemented with a program that causes the computer to function as the training apparatus 2000. In other words, the program is an implementation of the functional units of the training apparatus 2000. There are various ways to acquire the program. For example, the program can be acquired from a storage medium (such as a DVD disk or a USB memory) in which the program is stored in advance. In another example, the program can be acquired by downloading it from a server machine that manages a storage medium in which the program is stored in advance.

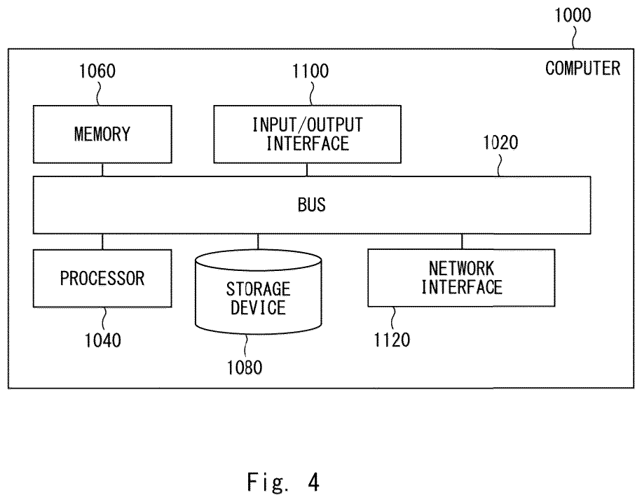

FIG. 4 is a block diagram illustrating an example of the hardware configuration of a computer 1000 realizing the training apparatus 2000 of the first example embodiment. In FIG. 4, the computer 1000 includes a bus 1020, a processor 1040, a memory 1060, a storage device 1080, an input/output (I/O) interface 1100, and a network interface 1120.

The bus 1020 is a data transmission channel in order for the processor 1040, the memory 1060, the storage device 1080, and the I/O interface 1100, and the network interface 1120 to mutually transmit and receive data. The processor 1040 is a processer, such as a CPU (Central Processing Unit), GPU (Graphics Processing Unit), FPGA (Field-Programmable Gate Array), or a DSP (Digital Signal Processor). The memory 1060 is a primary memory component, such as a RAM (Random Access Memory) or a ROM (Read Only Memory). The storage device 1080 is a secondary memory component, such as a hard disk, an SSD (Solid State Drive), or a memory card. The I/O interface 1100 is an interface between the computer 1000 and peripheral devices, such as a keyboard, mouse, or display device. The network interface 1120 is an interface between the computer 1000 and a network. The network may be a LAN (Local Area Network) or a WAN (Wide Area Network). The storage device 1080 may store the program mentioned above. The processor 1040 executes the program to realize each functional unit of the training apparatus 2000.

The hardware configuration of the computer 1000 is not restricted to that shown in FIG. 4. For example, as mentioned-above, the training apparatus 2000 may be realized by plural computers. In this case, those computers may be connected with each other through the network.

### <Flow of Process>

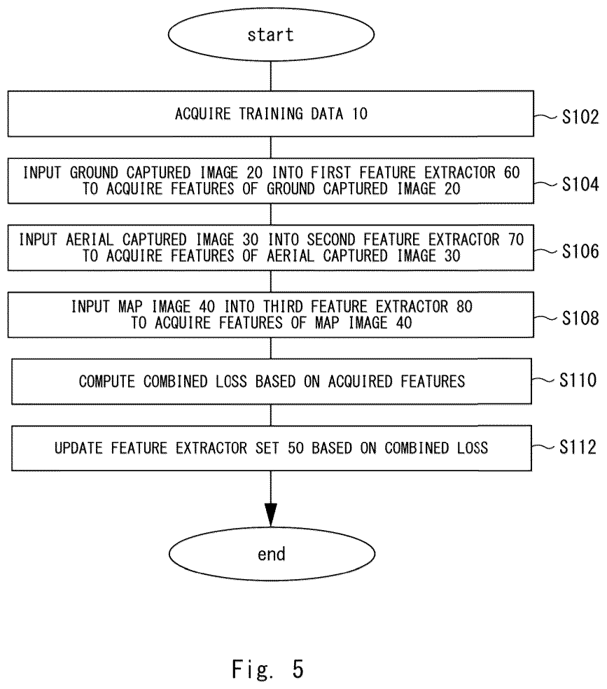

FIG. 5 shows a flowchart illustrating an example flow of process performed by the training apparatus 2000 of the first example embodiment. The acquiring unit 2020 acquires the training data 10 that includes the ground captured image 20, the aerial captured image 30, and the map image 40 (S102). The feature extracting unit 2040 inputs the ground captured image 20 into the first feature extractor 60, thereby obtaining the features of the ground captured image 20 (S104). The feature extracting unit 2040 inputs the aerial captured image 30 into the second feature extractor 70, thereby obtaining the features of the aerial captured image 30 (S106). The feature extracting unit 2040 inputs the map image 40 into the third feature extractor 80, thereby obtaining the features of the map image 40 (S108). The updating unit 2060 computes the combined loss based on the obtained features (S110). The updating unit 2060 updates the first feature extractor 60, the second feature extractor 70, and the third feature extractor 80 based on the combined loss (S112).

The flowchart shown by FIG. 5 is a merely example of possible flows of process performed by the training apparatus 2000, and the flow of process performed by the training apparatus 2000 is not limited to that shown by FIG. 5. For example, the extraction of the features from the ground captured image 20 (S104), that from the aerial captured image 30 (S106), and that from the map image 40 (S108) may be performed in a different order from that shown by FIG. 5 or may be performed in parallel.

As mentioned above, the training apparatus 2000 may use a plurality of training data 10 to train the feature extractor set 50. There are various well-known ways to use a plurality of training data to train feature extractors, and one of those ways can be applied to the training apparatus 2000. For example, the training apparatus 2000 may perform the process shown by FIG. 5 for each one of the plurality of training data 10. In another example, the training apparatus 2000 may perform batch training on the feature extractor set 50 using the plurality of the training data 10. In this case, the training apparatus 2000 may aggregate the combined losses obtained from the plurality of the training data 10 to obtain an aggregated loss, and update the feature extractor set 50 based on the aggregated loss. The aggregated loss may be a statistical value, such as an average value, of the combined losses.

### Example Application of Feature Extractor Set 50

As mentioned above, a whole or a part of the feature extractor set 50 may be used in an matching apparatus that performs cross-view image matching. Hereinafter, in order to make it easier to understand the feature extractor set 50, such the matching apparatus will be described as an example application of the feature extractor set 50.

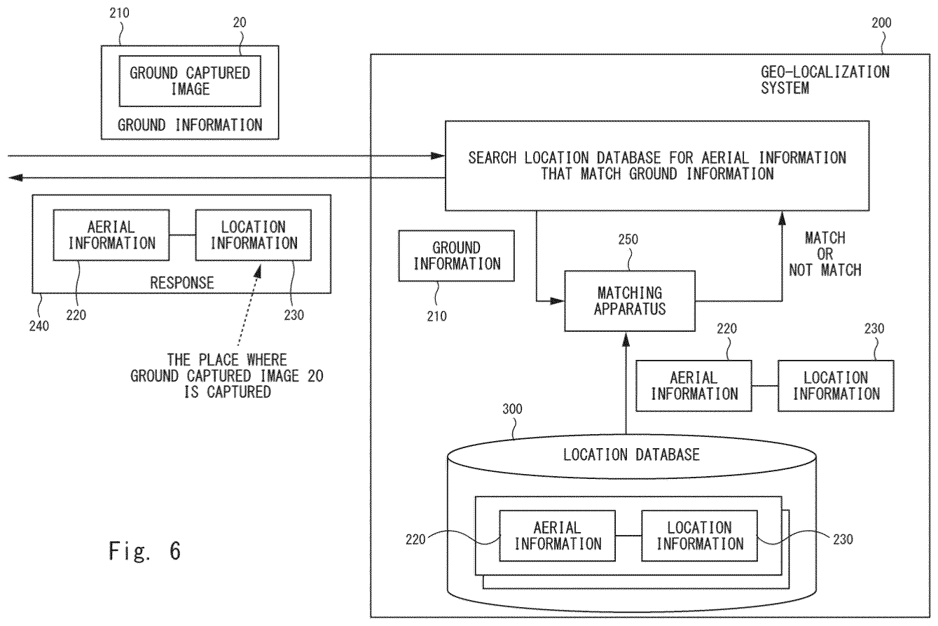

FIG. 6 illustrates a geo-localization system 200 in which a whole or a part of the feature extractor set 50 is employed. The geo-localization system 200 is a system that performs image geo-localization. Image geo-localization is a technique to determine the place at which an input image is captured. The geo-localization system 200 may be implemented by one or more arbitrary computers such as ones depicted in FIG. 4.

The geo-localization system 200 includes a matching apparatus 250. The matching apparatus 250 acquires ground information 210 and aerial information 220, and determines whether or not the ground information 210 matches the aerial information 220.

The ground information 210 includes an image in which a place is captured in ground view, i.e., a ground captured image 20. The aerial information 220 includes at least one type of image that shows a place in top view. When the second feature extractor 70 is employed in the matching apparatus 250, the aerial information 220 includes the aerial captured image 30. When the third feature extractor 80 is employed in the matching apparatus 250, the aerial information 220 includes the map image 40.

To determine whether or not the ground information 210 matches the aerial information 220, the matching apparatus 250 may compute similarity score that indicates a degree of similarity between a ground feature and an aerial feature. Then, the matching apparatus 250 determines that the ground information 210 matches the aerial information 220 when the similarity score is substantially large (e.g., larger than a predefined threshold).

The ground feature is a set of features extracted from the ground information 210: i.e., the features extracted from the ground captured image 20. The aerial feature is a set of features extracted from the aerial information 220: i.e., the features extracted from the aerial captured image 30, those extracted from the map image 40, or both.

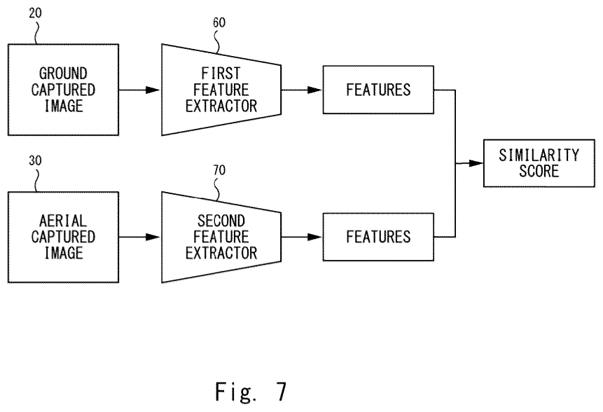

FIGS. 7 to 9 illustrate example ways of computing the similarity score. In an example shown by FIG. 7, the second feature extractor 70 is employed in the matching apparatus 250 while the third feature extractor 80 is not employed. In this case, the matching apparatus 250 computes a degree of similarity between the features of the ground captured image 20 and those of the aerial captured image 30 as the similarity score.

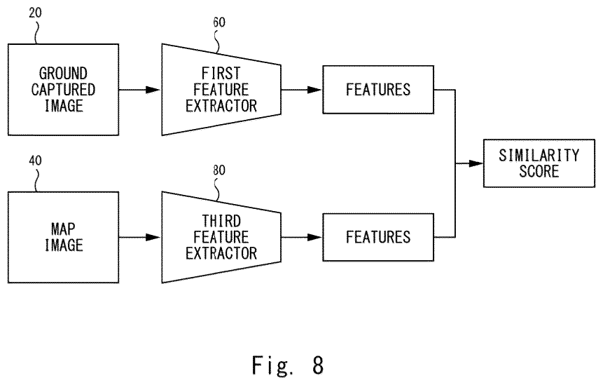

In an example shown by FIG. 8, the third feature extractor 80 is employed in the matching apparatus 250 while the second feature extractor 70 is not employed. In this case, the matching apparatus 250 computes a degree of similarity between the features of the ground captured image 20 and those of the map image 40 as the similarity score.

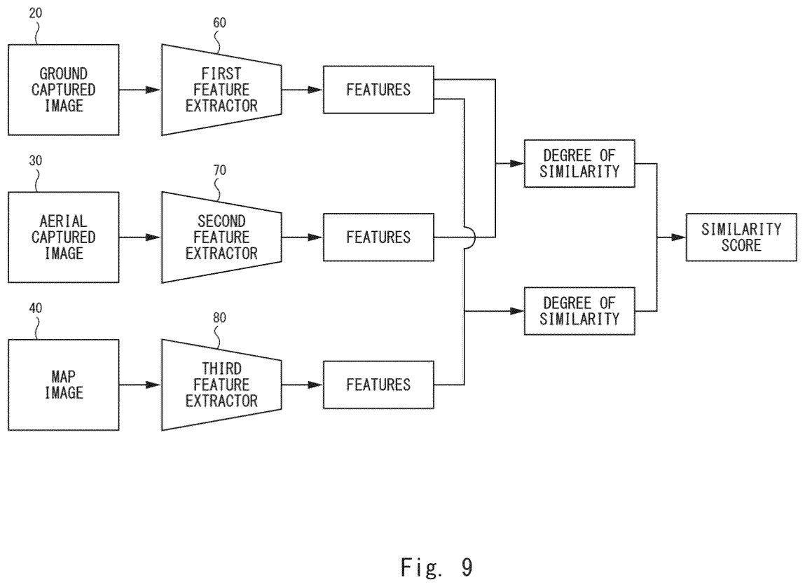

In an example shown by FIG. 9, both the second feature extractor 70 and the third feature extractor 80 are employed in the matching apparatus 250. In this case, the matching apparatus 250 computes a degree of similarity between the features of the ground captured image 20 and those of the aerial captured image 30 and a degree of similarity between the features of the ground captured image 20 and those of the map image 40, and combines them (e.g., compute their weighted average) to compute the similarity score.

Various metrics can be used to compute a degree of similarity between features. For example, the degree of similarity between features may be computed as one of various types of distance (e.g., L2 distance), correlation, cosine similarity, or NN (neural network) based similarity between features. The NN based similarity is the degree of similarity computed by a neural network that is trained to compute the degree of similarity between features that are input thereinto.

As shown by FIG. 6, the geo-localization system 200 also includes a location database 300. The location database 300 includes location information 230 in association with the aerial information 220 for each one of various locations. The location information 230 specifies a location of a place corresponding to the aerial information 220 associated with that location information 230.

When a user wants to know where the ground captured image 20 is captured, the user may operate a user terminal to send the ground information 210 in which that ground captured image 20 is included to the geo-localization system 200. The geo-localization system 200 receives the ground information 210, and searches the location database 300 for the aerial information 220 that matches the received ground information 210 to determine the place at which the ground captured image 20 in the ground information 210 is captured.

Specifically, until the aerial information 220 that matches the ground information 210 is detected, the geo-localization system 200 repeatedly executes to: acquire one of the pieces of the aerial information 220 from the location database 300; input a set of the ground information 210 and the aerial information 220 into the matching apparatus 250; and determine whether or not the matching apparatus 250 indicates that the ground information 210 matches the aerial information 220. When the aerial information 220 that matches the ground information 210 is detected, the geo-localization system 200 can determine that a place at which the ground captured image 20 in the ground information 210 is captured is the place specified by the location information 230 associated with the detected aerial information 220.

The geo-localization system 200 may send a response 240 to the user terminal. The response 240 may include the location information 230 that is determined by the geo-localization system 200 to specify the place where the ground captured image 20 is captured. The response 240 may also include the aerial information 220 that is determined by the geo-localization system 200 to match the ground information 210.

It is noted that the geo-localization system 200 can be configured to receive aerial information that includes an aerial captured image 30 and to determine a place at which the received aerial captured image 30 is captured. In this case, the location database 300 includes pairs of ground information and location information. In addition, the matching apparatus 250 includes the first feature extractor 60 and the second feature extractor 70.

Specifically, until the ground information that matches the received aerial information is detected, the geo-localization system 200 repeatedly executes to: acquire one of the pieces of the ground information from the location database 300; input a set of the aerial information and the ground information into the matching apparatus 250; and determine whether or not the matching apparatus 250 indicates that the aerial information matches the ground information. When the ground information that matches the received aerial information is detected, the geo-localization system 200 can determine that a place at which the aerial captured image 30 in the received aerial information is captured is the place specified by the location information associated with the detected ground information. Then, the geo-localization system sends a response to the user terminal. The response may include the detected ground information, the location information that is associated with the detected ground information, or both.

### <Acquisition of Training Data: S102>

The acquiring unit 2020 acquires the training data 10 (S102). There are various ways to acquire the training data 10. In some implementations, the acquiring unit 2020 may receive the training data 10 that is sent from another computer, such as one generates the training data 10. In other implementations, the training data may be stored in advance in a storage unit to which the acquiring unit 2020 has access. In this case, the acquiring unit 2020 reads the training data 10 out of this storage unit.

### <Extraction of Features: S104, S106, S108>

The feature extracting unit 2040 extracts features from the ground captures image 20, the aerial captured image 30, and the map image 40 (S104, S106, and S108). Specifically, the feature extracting unit 2040 retrieves the ground captured image 20 from the training data 10 and inputs the ground captured image 20 into the first feature extractor 60. Since the first feature extractor 60 is configured to extract features from an image that is input thereinto, the feature extracting unit 2040 can acquire the features of the ground captured image 20 from the first feature extractor 60. Similarly, the feature extracting unit 2040 retrieves the aerial captured image 30 from the training data 10 and inputs the aerial captured image 30 into the second feature extractor 70, thereby acquiring the features of the aerial captured image 30 from the second feature extractor 70. Furthermore, the feature extracting unit 2040 retrieves the map image 40 from the training data 10 and inputs the map image 40 into the third feature extractor 80, thereby acquiring the features of the map image 40 from the third feature extractor 80.

### <Computation of Combined Loss: S110>

The updating unit 2060 computes the combined loss based on the features of the ground captured image 20, those of the aerial captured image 30, and those of the map image 40 (S110). As mentioned above, the combined loss may be computed by combining a loss between the features of the ground captured image 20 and those of the aerial captured image 30, a loss between the features of the ground captured image 20 and those of the map image 40, and a loss between the features of the aerial captured image 30 and those of the map image 40. In this case, the combined loss may be computed using a following loss function L:

$$Expression 1$$

$$\begin{matrix}L ( {f}_{g} , {f}_{a} , {f}_{m} ) & = {W}_{ga} * {L}_{ga} ( {f}_{g} , {f}_{a} ) \\ & + {W}_{gm} * {L}_{gm} ( {f}_{g} , {f}_{m} ) \\ & + {W}_{am} * {L}_{am} ( {f}_{a} , {f}_{m} )\end{matrix} \qquad ( 1 )$$

In the expression (1), f_g, f_a, and f_m represent the features of the ground captures image 20, those of the aerial captured image 30, and those of the map image 40, respectively. It is noted that, outside the expression (1), subscripts are described using underscores. L represents a loss function to compute the combined loss. L_ga represents a loss function to compute the loss between the features of the ground captured image 20 and those of the aerial captured image 30. L_gm represents a loss function to compute the loss between the features of the ground captured image 20 and those of the map image 40. L_am represents a loss function to compute the loss between the features of the aerial captured image 30 and those of the map image 40. W_ga, W_gm, and Wam represent weights assigned to L_ga, L_gm, and Lam, respectively. When assigning an equal weight to L_ga, L_gm, and L_am, the weights W_ga, W_gm, and W_am can be removed from the expression (1).

There are various types of loss functions, and one of those loss functions (e.g., contrastive loss or triplet loss) may be employed as the loss function L_ga, L_gm, and L_am. Since the feature extractor set 50 may be used to perform matching between the ground information 210 and the aerial information 220 as exemplified with referring to FIG. 6, the loss between the ground information 210 and the aerial information 220 should be become substantially small when the ground information 210 and the aerial information 220 indicate a location same as each other and should be become not substantially small when the ground information 210 and the aerial information 220 indicate locations different from each other.

Specifically, the loss between the ground captured image 20 and the aerial captured image 30 should become substantially small when the location at which the ground captured image 20 is captured is substantially close to the center location of the aerial captured image 30 and should become not substantially small when the location at which the ground captured image 20 is captured is not substantially close to the center location of the aerial captured image 30. Similarly, the loss between the ground captured image 20 and the map image 40 should become substantially small when the location at which the ground captured image 20 is captured is substantially close to the center location of the map image 40 and should become not substantially small when the location at which the ground captured image 20 is captured is not substantially close to the center location of the map image 40.

To achieve this, the training apparatus 2000 may use both a training data 10 of positive example and that of negative example. The training data 10 of positive example meets a condition that the location where the ground captured image 20 is captured is substantially close to both the center location of the aerial captured image 30 and that of the map image 40. On the other hand, the training data 10 of negative example meets a condition that the location where the ground captured image 20 is captured is substantially close to neither the center location of the aerial captured image 30 nor that of the map image 40.

The training apparatus 2000 may use both a set of features extracted from the training data 10 of positive example and a set of the features extracted from the training data 10 of negative example to train the feature extractor set 50. There are various ways to use a positive example and a negative example to train feature extractors, and one of those ways can be applied to the training apparatus 2000.

It is noted that when triplet loss is employed, the training apparatus 2000 may use the training data 10 that includes both positive examples and negative examples. Specifically, the training data 10 may include a ground captured image 20, a pair of positive examples that includes an aerial captured image 30 of positive example and a map image 40 of positive example, and a pair of negative examples that includes an aerial captured image 30 of negative example and a map image 40 of negative example. The pair of positive examples meets a condition that the location where the ground captured image 20 is captured is substantially close to both the center location of the aerial captured image 30 of positive example and that of the map image 40 of positive example. On the other hand, the pair of negative examples meets a condition that the location where the ground captured image 20 is captured is substantially close to neither the center location of the aerial captured image 30 of negative example nor that of the map image 40 of negative example. In addition, the center locations of the aerial captured image 30 and the map image 40 in the same pair as each other are substantially close to each other.

The training apparatus 2000 may use the features extracted from each image in the training data 10: the features extracted from the ground image 20, those extracted from the aerial captured image 30 of positive example, those extracted from the aerial captured image 30 of negative example, those extracted from the map image 40 of positive example, and those extracted from the map image 40 of negative example.

When triplet loss is employed, a loss function to compute the combined loss may be defined as follows.

$$Expression 2$$

$$\begin{matrix}L ( {f}_{g} , {f}_{ap} , {f}_{an} , {f}_{mp} , {f}_{mn} ) & = {W}_{ga} * {L}_{ga} ( {f}_{g} , {f}_{ap} , {f}_{an} ) \\ & + {W}_{gm} * {L}_{gm} ( {f}_{g} , {f}_{mp} , {f}_{mn} ) \\ & + {W}_{gam} * {L}_{gam} ( {f}_{g} , {f}_{ap} , {f}_{mn} ) \\ & + {W}_{gma} * {L}_{gma} ( {f}_{g} , {f}_{mp} , {f}_{an} )\end{matrix} \qquad ( 2 )$$

In the expression (2), f_ap, f_an, f_mp, f_mn represent the features of the aerial captured image 30 of positive example, those of the aerial captured image 30 of negative example, those of the map image 40 of positive example, and those of the map image 40 of negative example, respectively. L_ga represents a triplet loss function to compute a triplet loss among the features of the ground captured image 20, those of the aerial captured image 30 of positive example, and those of the aerial captured image 30 of negative example. L_gm represents a triplet loss function to compute a triplet loss among the features of the ground captured image 20, those of the map image 40 of positive example, and those of the map image 40 of negative example. L_gam represents a triplet loss function to compute a triplet loss among the features of the ground captured image 20, those of the aerial captured image 30 of positive example, and those of the map image 40 of negative example. Lgma represents a triplet loss function to compute a triplet loss among the features of the ground captured image 20, those of the map image 40 of positive example, and those of the aerial captured image 30 of negative example. W_gam and W_gma represent weights assigned to L_gam and L_gma, respectively.

### <Update of Feature Extractor Set 50: S112>

The updating unit 2060 updates the feature extractor set 50 based on the combined loss (S112). The first feature extractor 60, the second feature extractor 70, and the third feature extractor 80 are configured to have some trainable parameters: e.g., weights assigned to respective connections of neural networks. Thus, the updating unit 2060 updates the feature extractor set 50 by updating the trainable parameters of the first feature extractor 60, those of the second feature extractor 70, and those of the third feature extractor 80 based on the combined loss. It is noted that there are various well-known ways to update trainable parameters of feature extractors using the loss that is computed based on the features obtained from those feature extractors, and one of those ways can be applied to the updating unit 2060.

<Output from Training Apparatus 2000>

The training apparatus 2000 may output the result of the training of the feature extractor set 50. The result of the training may be output in an arbitrary manner. For example, the training apparatus 2000 may save trained parameters (e.g., weights assigned to respective connections of neural networks) of the first feature extractor 60, the second feature extractor 70, and the third feature extractor 80 on a storage unit. In another example, the training apparatus 2000 may send the trained parameters to another apparatus, such as the matching apparatus 250. It is noted that not only the parameters but also the program implementing the feature extractor set 50 may be output.

In the case where the matching apparatus 250 is implemented in the training apparatus 2000, the training apparatus 2000 may not output the result of the training. In this case, from the viewpoint of the user of the training apparatus 2000, it is preferable that the training apparatus 2000 notifies the user that the training of the matching apparatus 250 has finished.

### Second Example Embodiment

### Overview

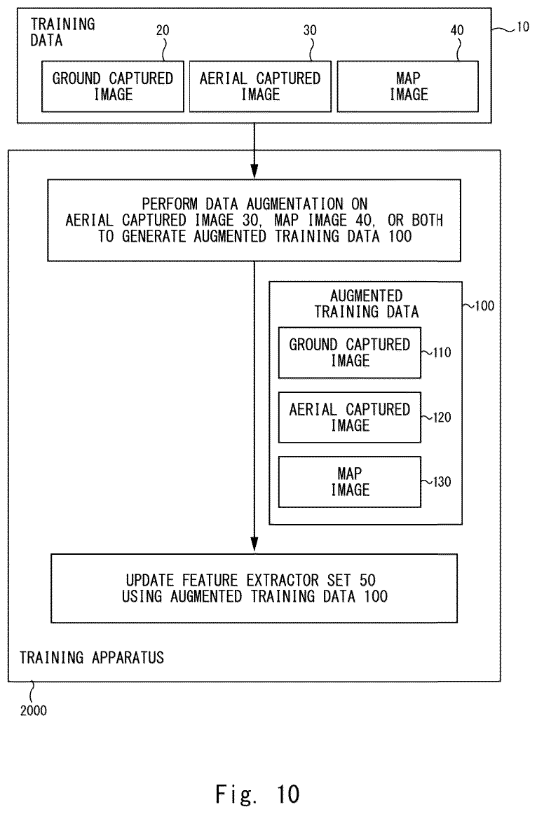

FIG. 10 illustrates an overview of a training apparatus 2000 of the second example embodiment. Please note that FIG. 10 does not limit operations of the training apparatus 2000, but merely show an example of possible operations of the training apparatus 2000. Unless otherwise stated, the training apparatus 2000 of the second example embodiment includes all the functions that are included in that of the first example embodiment.

The training apparatus 2000 of the second example embodiment is further configured to perform data augmentation on the training data 10 to generate an augmented training data 100 that includes a ground captured image 110, an aerial captured image 120, and a map image 130. The ground captured image 110 is the same image as the ground captured image 20 in the training data 10. On the other hand, the aerial captured image 120, the map image 130, or both are generated based on the aerial captured image 30 and the map image 40 in the training data 10, and therefore partially different from their counterparts in the training data 10.

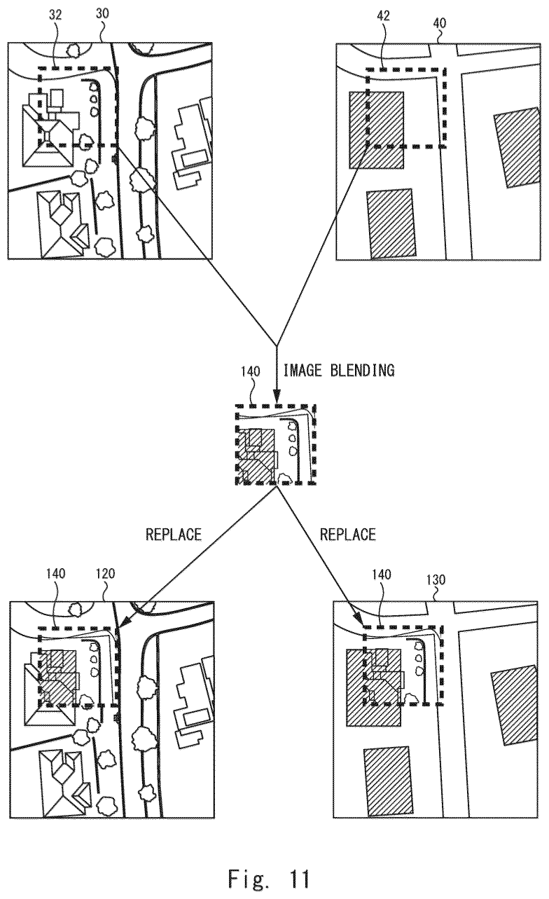

The data augmentation performed by the training apparatus 2000 includes image blending between a part of the aerial captured image 30 and a part of the map image 40. FIG. 11 illustrates an example of data augmentation performed by the training apparatus 2000. In FIG. 11, a partial image 32 in the aerial captured image 30 and a partial image 42 in the map image 40 are subject to image blending.

Specifically, the training apparatus 2000 blends the partial image 32 and the partial image 42 with a blending ratio of Ra:Rm to obtain an augmented image 140 (Ra=Rm=0.5 in the case of the FIG. 11). Then, the training apparatus 2000 generates the aerial captured image 120 by replacing the partial image 32 in the aerial captured image 30 with the augmented image 140. Similarly, the training apparatus 2000 generates the map image 130 by replacing the partial image 42 in the map image 40 with the augmented image 140.

Although a single augmented image 140 is used for both the replacement of the partial image 32 and that of the partial image 42 in the case of FIG. 11, the training apparatus 2000 may use the augmented image 140 for either one of the replacement of the partial image 32 or that of the partial image 42.

The training apparatus 2000 of the second example embodiment trains the feature extractor set 50 using the augmented training data 100 in a way similar to that with which the training apparatus 2000 of the first example embodiment trains the feature extractor set 50 using the training data 10. Specifically, the training apparatus 2000 inputs the ground captured image 110, the aerial captured image 120, and the map image 130 into the first feature extractor 60, the second feature extractor 70, and the third feature extractor 80, respectively. By doing so, the training apparatus 2000 acquires the features of the ground captured image 110, those of the aerial captured image 120, and those of the map image 130. Then, the training apparatus 2000 computes the combined loss based on the features of the ground captured image 110, those of the aerial captured image 120, and those of the map image 130, and updates the feature extractor set 50 based on the combined loss.

It is noted that the training apparatus 2000 may modify either one of the aerial captured image 30 or the map image 40 to generate the augmented training data 100. In this case, either one of the aerial captured image 120 or the map image 130 is the same as its counterpart in the training data 10.

### Example of Advantageous Effect

According to the training apparatus 2000 of the second example embodiment, the augmented training data 100 is generated by performing data augmentation with the training data 10. The data augmentation may include the image blending with which a part of the aerial captured image 30 and a part of the map image 40 (i.e., the partial image 32 and the partial image 42) are blended to generate the augmented image 140, and at least one of them is replaced to generate the aerial captured image 120, the map image 130, or both that are included in the augmented training data 100. Thus, a novel technique to perform data augmentation to generate an image for a training of feature extractors is provided.

In addition, the data augmentation performed by the training apparatus 2000 can_help to increase the amount of information in the map image 40. The map image 40 may not always be detailed. The degree of detail of the map image 40 may depend on a type of mapping technology that is employed to generate the map image 40 or on efforts taken to generate the map image 40. For example, detailed information (e.g., trees, buildings, or parking lots) may be omitted in the map image 40. By blending a part of the map image 40 with the corresponding part of the aerial captured image 30, it is possible to add more details to the map image 40.

The data augmentation performed by the training apparatus 2000 can also help to simplify the information for the aerial captured image 30. Due to high amount of detail present in the aerial captured image 30, it takes time for the feature extractor set 50 to learn meaningful feature. By reducing the detail in the aerial captured image 30, it is possible to prevent the feature extractor set 50 from focusing on detailed information (e.g., color) and to enable the feature extractor 50 to learn concept, thereby reducing training time and simplifying feature learning process.

Hereinafter, more detailed explanation of the training apparatus 2000 will be described.

### Example of Functional Configuration

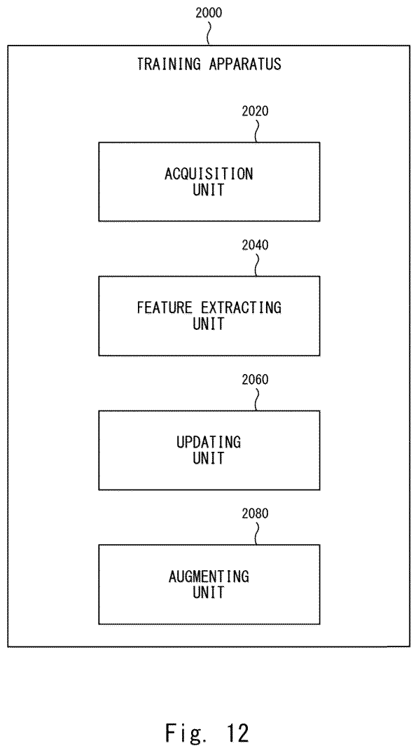

FIG. 12 is a block diagram showing an example of the functional configuration of the training apparatus 2000 of the second example embodiment. As depicted by FIG. 12, the training apparatus 2000 of the second example embodiment includes an augmenting unit 2080 in addition to the functional units that are also included in the training apparatus 2000 of the first example embodiment. The augmenting unit 2080 generates the augmented training data 100 based on the training data 10. The feature extracting unit 2040 of the second example embodiment inputs the ground captured image 110, the aerial captured image 120, and the map image 130 in the augmented training data 100 into the first feature extractor 60, the second feature extractor 70, and the third feature extractor 80, respectively. By doing so, the feature extracting unit 2040 acquires the features of the ground captured image 110, those of the aerial captured image 120, and those of the map image 130. The updating unit 2060 computes the combined loss based on the features of the ground captured image 110, those of the aerial captured image 120, and those of the map image 130, and updates the feature extractor set 50 based on the combined loss.

### Example of Hardware Configuration

The training apparatus 2000 of the second example embodiment may be realized by one or more computers similarly to that of the first example embodiment. Thus, the hardware configuration of the training apparatus 2000 of the second example embodiment may be depicted by FIG. 4 similarly to that of the first example embodiment. However, the storage device 1080 of the second example embodiment includes the program with which the training apparatus 2000 of the second example embodiment is implemented.

### <Flow of Process>

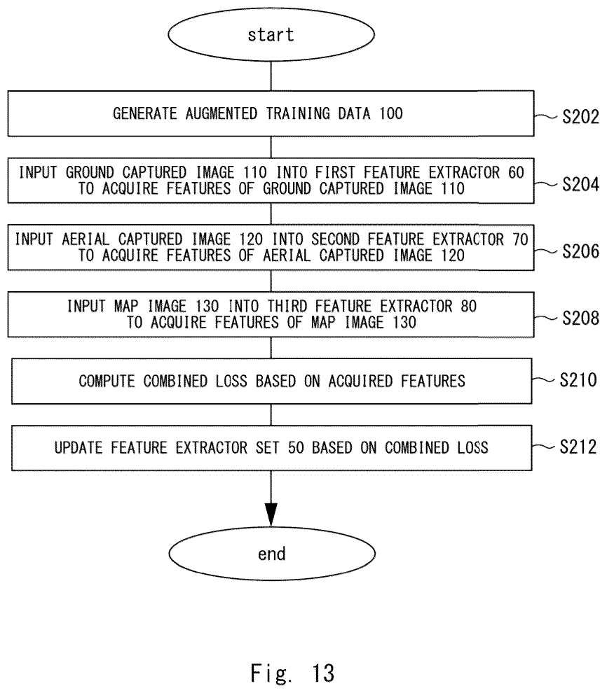

FIG. 13 shows a flowchart illustrating an example flow of process performed by the training apparatus 2000 of the second example embodiment. The training apparatus 2000 may perform the process shown by FIG. 13 in addition to the process shown by FIG. 5. The augmenting unit 2080 generates the augmented training data 100 from the training data 10 (S202). The feature extracting unit 2040 inputs the ground captured image 110 into the first feature extractor 60, thereby obtaining the features of the ground captured image 110 (S204). The feature extracting unit 2040 inputs the aerial captured image 120 into the second feature extractor 70, thereby obtaining the features of the aerial captured image 120 (S206). The feature extracting unit 2040 inputs the map image 130 into the third feature extractor 80, thereby obtaining the features of the map image 130 (S208). The updating unit 2060 computes the combined loss based on the obtained features (S210). The updating unit 2060 updates the first feature extractor 60, the second feature extractor 70, and the third feature extractor 80 based on the combined loss (S212).

Similarly to the flow of process performed by the training apparatus 2000 of the first example embodiment, the flow of process performed by the training apparatus 2000 of the second example embodiment is not limited to that shown by FIG. 13. For example, the extraction of the features from the ground captured image 110 (S204), that from the aerial captured image 120 (S206), and that from the map image 130 (S208) may be performed in a different order from that shown by FIG. 13 or may be performed in parallel.

The training apparatus 2000 of the second example embodiment may use a plurality of augmented training data 100 to train the feature extractor set 50 in a way similar to that with which the training apparatus 2000 uses a plurality of training data 10. In addition, when the training apparatus 2000 of the second example embodiment performs batch training on the feature extractor set 50, the training apparatus 2000 may compute the combined losses from the training data 10 and the augmented training data 100 to aggregate them.

### <Data Augmentation: S202>

The augmenting unit 2080 performs data augmentation on the training data 10 to generate the augmented training data 100 from the training data 10 (S202). The data augmentation performed by the augmenting unit 2080 includes image blending between the aerial captured image 120 and the map image 130. Hereinafter, examples of the data augmentation are described in detail.

The augmenting unit 2080 may determine one or more pairs, called “partial image pairs”, of the partial image 32 and the partial image 42 that are subject to the image blending. The partial image 32 and the partial image 42 of a partial image pair are located at the same position as each other and have the same shape and size as each other. Thus, the augmenting unit 2080 may determine each partial image pair by determining its position, shape, and size.

The partial image pair may be represented by a tuple Ai=(Pi, SHi, SZi) where i represents an identifier of the partial image pair, Ai represents the i-th partial image pair, Pi represents the position of the partial image 32 and the partial image 42 of the i-th partial image pair, SHi represents the shape of the partial image 32 and the partial image 42 of the i-th partial image pair, and SZi represents the size of the partial image 32 and the partial image 42 of the i-th partial image pair. In this case, the partial image 32 of Ai is at the position Pi in the aerial captured image 30 and has the shape SHi and the size SZi. Similarly, the partial image 42 of Ai is at the position Pi in the map image 40 and has the shape SHi and the size SZi.

The shape of the partial image may be one of predefined shapes, such as rectangle or circle. There are various ways to represent a position and a size of a partial image, and one of those ways can be applied to the partial image pairs. Suppose that the shape of the partial images is a rectangle. In this case, the position of the partial image may be represented by coordinates of one of its vertexes (e.g., the top-left vertex) while the size thereof may be represented by a pair of its width and height (in other words, the length of its longer side and that of its sorter side).

In another example, the shape of the partial images may be a circle. In this case, the position of the partial image may be represented by coordinates of its center while the size thereof may be represented by its radius or diameter.

The partial image pair may be defined in advance or may be dynamically determined by the augmenting unit 2080. In the former case, information that shows a definition, such as a tuple (Pi, SHi, SZi), of each partial image pair is stored in advance in a storage unit to which the augmenting unit 2080 has access. The augmenting unit 2080 acquires this information from this storage unit to determine the partial image pairs to be used in the data augmentation. The augmenting unit 2080 may use all the predefined partial image pairs for the data augmentation, or may choose one or more partial image pairs from the predefined ones for the data augmentation. In the latter case, the number of the partial image pairs to be chosen may be predefined or may be dynamically determined (e.g., determined at random).

When the partial image pairs are dynamically determined, the augmenting unit 2080 may dynamically determine (e.g., determine at random) the number of the partial image pairs. Then, for each partial image pair, the augmenting unit 2080 may dynamically determine (e.g., determine at random) the position, the shape, and the size of that partial image pair.

It is noted that the number of the partial image pair may be defined in advance. In this case, the augmenting unit 2080 may determine the predefined number of partial image pairs by dynamically determining the position, the shape, and the size for each partial image pair.

It is also noted that one or more of the position, the shape, and the size may be defined in advance. Suppose that the shape of the partial image pair is defined as rectangle in advance. In this case, the augmenting unit 2080 determines the position and the size of the rectangle to determine the partial image pair in the shape of rectangle.

After determining the partial image pairs, for each partial image pair, the augmenting unit 2080 performs image blending to generate an augmented image 140. In the image blending, the partial image 32 and the partial image 42 are blended with each other with a blending ratio Ra:Rm where Ra+Rm=1. The blending ratio may be common in all the partial image pairs, or may be individually determined for each partial image pair. In addition, the blending ratio may be defined in advance or may be dynamically determined, e.g., determined at random.

After generating the augmented image 140, the augmenting unit 2080 may replace the partial image 32 with the augmented image 140 to generate the aerial captured image 120, replace the partial image 42 with the augmented image 140 to generate the map image 130, or do both. For each augmented image 140, the partial image to be replaced with it may be defined in advance or may be dynamically chosen (e.g., chosen at random).

It is noted that, for one or more partial image pairs, the augmenting unit 2080 may not use either the partial image 32 or the partial image 42 of the partial image pair to generate the augmented image 140. It can be rephrased that the image blending may be performed with the blending ratio of 1:0 (Ra=1 and Rm=0) or 0:1 (Ra=0 and Rm=1).

When the augmented image 140 is generated with the blending ratio of 1:0 (i.e., the partial image 42 is not used to generate the augmented image 140) and the partial image 42 is replaced with this augmented image 140, it means that a part of the map image 40 is completely replaced with its counterpart of the aerial captured image 30.

This process can be performed without image blending. Specifically, the augmenting unit 2080 may extract the partial image 32 as the augmented image 140, and perform image replacement on the map image 40 to replace the partial image 42 with this augmented image 140.

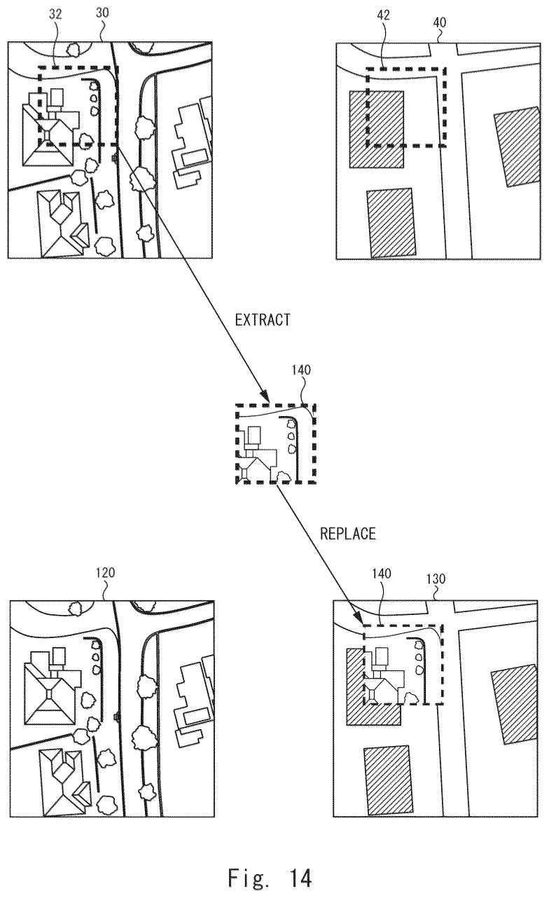

FIG. 14 illustrates a case where a part of the map image 40 is replaced with its counterpart of the aerial captured image 30. In the map image 130, the partial image 42 is replaced with the augmented image 140 that is equivalent to the partial image 32.

Similarly, when the augmented image 140 is generated with the blending ratio of 0:1 (i.e., the partial image 32 is not used to generate the augmented image 140) and the partial image 32 is replaced with this augmented image 140, it means that a part of the aerial captured image 30 is completely replaced with its counterpart of the map image 40.

This process can also be performed without image blending. Specifically, the augmenting unit 2080 may extract the partial image 42 as the augmented 140, and perform image replacement on the aerial captured image 30 to replace the partial image 32 with this augmented image 140.

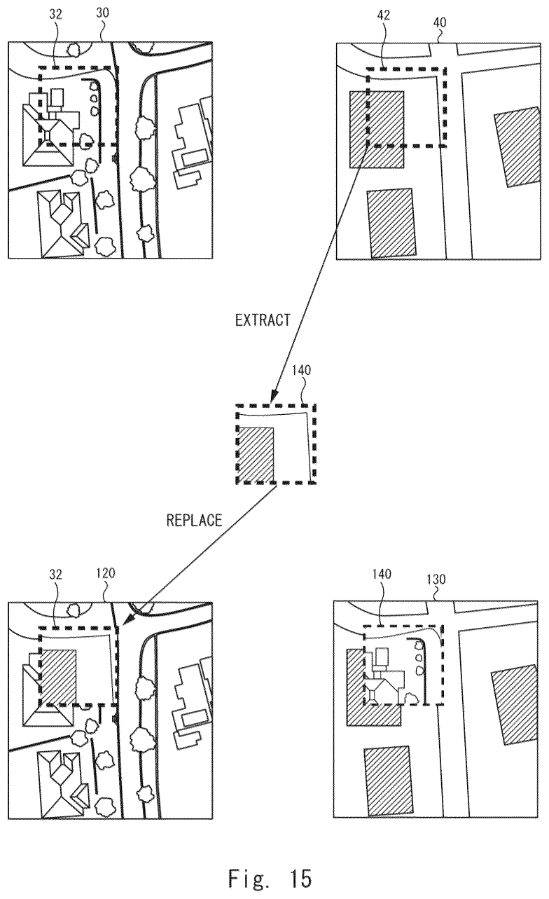

FIG. 15 illustrates a case where a part of the aerial captured image 30 is replaced with its counterpart of the map image 40. In the aerial captured image 120, the partial image 32 is replaced with the augmented image 140 that is equivalent to the partial image 42.

It is noted that, in addition to the image blending mentioned above, the augmenting unit 2080 may perform one or more methods for data augmentation on the aerial captured image 30, the map image 40, or both. Examples of those methods are disclosed by PTL1 and PTL2.

<Output from Training Apparatus 2000>

The training apparatus 2000 of the second example embodiment may output the same information as that output by the training apparatus 2000 of the first example embodiment. In addition, the training apparatus 2000 of the second example embodiment may output the augmented training data 100.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Although the present disclosure is explained above with reference to example embodiments, the present disclosure is not limited to the above-described example embodiments. Various modifications that can be understood by those skilled in the art can be made to the configuration and details of the present disclosure within the scope of the invention.

The whole or part of the example embodiments disclosed above can be described as, but not limited to, the following supplementary notes.

### <Supplementary Notes>

### (Supplementary Note 1)

A training apparatus comprising:
at least one memory that is configured to store instructions; and at least one processor that is configured to execute the instructions to:
acquire a training data including a first ground captured image, a first aerial captured image, and a first map image;
input the first ground captured image to a first feature extractor to extract features of the first ground captured image;
input the first aerial captured image to a second feature extractor to extract features of the first aerial captured image;
input the first map image to a third feature extractor to extract features of the first map image;
compute a combined loss based on the features of the first ground captured image, the features of the first aerial captured image, and the features of the first map image; and
update the first feature extractor, the second feature extractor, and the third feature extractor based on the combined loss.

### (Supplementary Note 2)

The training apparatus according to supplementary note 1, wherein the computation of the combined loss includes:
computing a first loss based on the features of the first ground captured image and the features of the first aerial captured image;
computing a second loss based on the features of the first ground captured image and the features of the first map image;
computing a third loss based on the features of the first aerial captured image and the features of the first map image; and combining the first loss, the second loss, and the third loss into the combined loss.

### (Supplementary Note 3)

The training apparatus according to supplementary note 2,
wherein the combined loss is a weighted sum of the first loss, the second loss, and the third loss.

### (Supplementary Note 4)

The training apparatus according to any one of supplementary notes 1 to 3,
wherein the at least one process is further configured to:
generate an augmented training data based on the training data, the augmented training data including a second ground captured image, a second aerial captured image, and a second map image,
wherein the generation of the augmented training data includes:
blending a part of the first aerial captured image and a part of the first map image to generate an augmented image; and
replacing the part of the first aerial captured image with the augmented image to obtain the second aerial captured image, replacing the part of the first map image with the augmented image to obtain the second map image, or doing both.

### (Supplementary Note 5)

The training apparatus according to supplementary note 4,
wherein the generation of the augmented training data further includes: determining one or more partial image pairs each of which is a pair of a part of the first aerial captured image and a part of the first map image; and
generating the augmented image for each partial image pair, wherein the part of the first aerial captured image and the part of the first map image that are included in a partial image pair have a same position, a same shape, and a same size as each other, and
the determination of the partial image pair includes determining the position, the shape, and the size for the partial image pair.

### (Supplementary Note 6)

The training apparatus according to supplementary note 4,
wherein the at least one processor is further configured to:
input the second ground captured image to a first feature extractor to extract features of the second ground captured image;
input the second aerial captured image to a second feature extractor to extract features of the second aerial captured image;
input the second map image to a third feature extractor to extract features of the second map image;
compute a second combined loss based on the features of the second ground captured image, the features of the second aerial captured image, and the features of the second map image; and
update the first feature extractor, the second feature extractor, and the third feature extractor based on the second combined loss.

### (Supplementary Note 7)

A training method performed by a computer, comprising:
acquiring a training data including a first ground captured image, a first aerial captured image, and a first map image;
inputting the first ground captured image to a first feature extractor to extract features of the first ground captured image;
inputting the first aerial captured image to a second feature extractor to extract features of the first aerial captured image;
inputting the first map image to a third feature extractor to extract features of the first map image;
computing a combined loss based on the features of the first ground captured image, the features of the first aerial captured image, and the features of the first map image; and
updating the first feature extractor, the second feature extractor, and the third feature extractor based on the combined loss.

### (Supplementary Note 8)

The training method according to supplementary note 7,
wherein the computation of the combined loss includes:
computing a first loss based on the features of the first ground captured image and the features of the first aerial captured image;
computing a second loss based on the features of the first ground captured image and the features of the first map image;
computing a third loss based on the features of the first aerial captured image and the features of the first map image; and
combining the first loss, the second loss, and the third loss into the combined loss.

### (Supplementary Note 9)

The training method according to supplementary note 8,
wherein the combined loss is a weighted sum of the first loss, the second loss, and the third loss.

### (Supplementary Note 10)

The training method according to any one of supplementary notes 7 to 9, further comprising:
generating an augmented training data based on the training data, the augmented training data including a second ground captured image, a second aerial captured image, and a second map image,
wherein the generation of the augmented training data includes:
blending a part of the first aerial captured image and a part of the first map image to generate an augmented image; and
replacing the part of the first aerial captured image with the augmented image to obtain the second aerial captured image, replacing the part of the first map image with the augmented image to obtain the second map image, or doing both.

### (Supplementary Note 11)

The training method according to supplementary note 10,
wherein the generation of the augmented training data further includes:
determining one or more partial image pairs each of which is a pair of a part of the first aerial captured image and a part of the first map image; and
generating the augmented image for each partial image pair, wherein the part of the first aerial captured image and the part of the first map image that are included in a partial image pair have a same position, a same shape, and a same size as each other, and
the determination of the partial image pair includes determining the position, the shape, and the size for the partial image pair.

### (Supplementary Note 12)

The training method according to supplementary note 10, further comprising:
inputting the second ground captured image to a first feature extractor to extract features of the second ground captured image;
inputting the second aerial captured image to a second feature extractor to extract features of the second aerial captured image;
inputting the second map image to a third feature extractor to extract features of the second map image;
computing a second combined loss based on the features of the second ground captured image, the features of the second aerial captured image, and the features of the second map image; and
updating the first feature extractor, the second feature extractor, and the third feature extractor based on the second combined loss.

### (Supplementary Note 13)

A non-transitory computer-readable storage medium storing a program that causes a computer to execute:
acquiring a training data including a first ground captured image, a first aerial captured image, and a first map image;
inputting the first ground captured image to a first feature extractor to extract features of the first ground captured image;
inputting the first aerial captured image to a second feature extractor to extract features of the first aerial captured image;
inputting the first map image to a third feature extractor to extract features of the first map image;
computing a combined loss based on the features of the first ground captured image, the features of the first aerial captured image, and the features of the first map image; and
updating the first feature extractor, the second feature extractor, and the third feature extractor based on the combined loss.

### (Supplementary Note 14)

The storage medium according to supplementary note 13, wherein the computation of the combined loss includes:
computing a first loss based on the features of the first ground captured image and the features of the first aerial captured image;
computing a second loss based on the features of the first ground captured image and the features of the first map image;
computing a third loss based on the features of the first aerial captured image and the features of the first map image; and
combining the first loss, the second loss, and the third loss into the combined loss.

### (Supplementary Note 15)

The storage medium according to supplementary note 14,
wherein the combined loss is a weighted sum of the first loss, the second loss, and the third loss.

### (Supplementary Note 16)

The storage medium according to any one of supplementary notes 13 to 15,
wherein the program causes the computer to further execute:
generating an augmented training data based on the training data, the augmented training data including a second ground captured image, a second aerial captured image, and a second map image,
wherein the generation of the augmented training data includes:
blending a part of the first aerial captured image and a part of the first map image to generate an augmented image; and
replacing the part of the first aerial captured image with the augmented image to obtain the second aerial captured image, replacing the part of the first map image with the augmented image to obtain the second map image, or doing both.

### (Supplementary Note 17)

The storage medium according to supplementary note 16,
wherein the generation of the augmented training data further includes: determining one or more partial image pairs each of which is a pair of a part of the first aerial captured image and a part of the first map image; and
generating the augmented image for each partial image pair,
wherein the part of the first aerial captured image and the part of the first map image that are included in a partial image pair have a same position, a same shape, and a same size as each other, and
the determination of the partial image pair includes determining the position, the shape, and the size for the partial image pair.

### (Supplementary Note 18)

The storage medium according to supplementary note 16,
wherein the program causes the computer to further execute:
inputting the second ground captured image to a first feature extractor to extract features of the second ground captured image;
inputting the second aerial captured image to a second feature extractor to extract features of the second aerial captured image;
inputting the second map image to a third feature extractor to extract features of the second map image;
computing a second combined loss based on the features of the second ground captured image, the features of the second aerial captured image, and the features of the second map image; and
updating the first feature extractor, the second feature extractor, and the third feature extractor based on the second combined loss.

### REFERENCE SIGNS LIST

10 training data
20 ground captured image
30 aerial captured image
40 map image
50 feature extractor set
60 first feature extractor
70 second feature extractor
80 third feature extractor
100 augmented training data
110 ground captured image
120 aerial captured image
130 map image
140 augmented image
200 geo-localization system
210 ground information
220 aerial information
230 location information
240 response
250 matching apparatus
300 location database
1000 computer
1020 bus
1040 processor
1060 memory
1080 storage device
1100 input/output interface
1120 network interface
2000 training apparatus
2020 acquiring unit
2040 feature extracting unit
2060 updating unit
2080 augmenting unit

What is claimed is:

1. A training apparatus comprising:
at least one memory that is configured to store instructions; and
at least one processor that is configured to execute the instructions to:
acquire a training data including a first ground captured image, a first aerial captured image, and a first map image;
input the first ground captured image to a first feature extractor to extract features of the first ground captured image;
input the first aerial captured image to a second feature extractor to extract features of the first aerial captured image;
input the first map image to a third feature extractor to extract features of the first map image;
compute a combined loss based on the features of the first ground captured image, the features of the first aerial captured image, and the features of the first map image; and
update the first feature extractor, the second feature extractor, and the third feature extractor based on the combined loss.

2. The training apparatus according to claim 1,
wherein the computation of the combined loss includes:
computing a first loss based on the features of the first ground captured image and the features of the first aerial captured image;
computing a second loss based on the features of the first ground captured image and the features of the first map image;
computing a third loss based on the features of the first aerial captured image and the features of the first map image; and
combining the first loss, the second loss, and the third loss into the combined loss.

3. The training apparatus according to claim 2,
wherein the combined loss is a weighted sum of the first loss, the second loss, and the third loss.

4. The training apparatus according to claim 1,
wherein the at least one process is further configured to:
generate an augmented training data based on the training data, the augmented training data including a second ground captured image, a second aerial captured image, and a second map image,
wherein the generation of the augmented training data includes:
blending a part of the first aerial captured image and a part of the first map image to generate an augmented image; and
replacing the part of the first aerial captured image with the augmented image to obtain the second aerial captured image, replacing the part of the first map image with the augmented image to obtain the second map image, or doing both.

5. The training apparatus according to claim 4,
wherein the generation of the augmented training data further includes:
determining one or more partial image pairs each of which is a pair of a part of the first aerial captured image and a part of the first map image; and
generating the augmented image for each partial image pair,
wherein the part of the first aerial captured image and the part of the first map image that are included in a partial image pair have a same position, a same shape, and a same size as each other, and
the determination of the partial image pair includes determining the position, the shape, and the size for the partial image pair.

6. The training apparatus according to claim 4,
wherein the at least one processor is further configured to:
input the second ground captured image to a first feature extractor to extract features of the second ground captured image;
input the second aerial captured image to a second feature extractor to extract features of the second aerial captured image;
input the second map image to a third feature extractor to extract features of the second map image;
compute a second combined loss based on the features of the second ground captured image, the features of the second aerial captured image, and the features of the second map image; and
update the first feature extractor, the second feature extractor, and the third feature extractor based on the second combined loss.

7. A training method performed by a computer, comprising:
acquiring a training data including a first ground captured image, a first aerial captured image, and a first map image;
inputting the first ground captured image to a first feature extractor to extract features of the first ground captured image;
inputting the first aerial captured image to a second feature extractor to extract features of the first aerial captured image;
inputting the first map image to a third feature extractor to extract features of the first map image;
computing a combined loss based on the features of the first ground captured image, the features of the first aerial captured image, and the features of the first map image; and
updating the first feature extractor, the second feature extractor, and the third feature extractor based on the combined loss.

8. The training method according to claim 7,
wherein the computation of the combined loss includes:
computing a first loss based on the features of the first ground captured image and the features of the first aerial captured image;
computing a second loss based on the features of the first ground captured image and the features of the first map image;
computing a third loss based on the features of the first aerial captured image and the features of the first map image; and
combining the first loss, the second loss, and the third loss into the combined loss.

9. The training method according to claim 8,
wherein the combined loss is a weighted sum of the first loss, the second loss, and the third loss.

10. The training method according to claim 7, further comprising:
generating an augmented training data based on the training data, the augmented training data including a second ground captured image, a second aerial captured image, and a second map image,
wherein the generation of the augmented training data includes:
blending a part of the first aerial captured image and a part of the first map image to generate an augmented image; and
replacing the part of the first aerial captured image with the augmented image to obtain the second aerial captured image, replacing the part of the first map image with the augmented image to obtain the second map image, or doing both.

11. The training method according to claim 10,
wherein the generation of the augmented training data further includes:
determining one or more partial image pairs each of which is a pair of a part of the first aerial captured image and a part of the first map image; and
generating the augmented image for each partial image pair,
wherein the part of the first aerial captured image and the part of the first map image that are included in a partial image pair have a same position, a same shape, and a same size as each other, and
the determination of the partial image pair includes determining the position, the shape, and the size for the partial image pair.

12. The training method according to claim 10, further comprising:
inputting the second ground captured image to a first feature extractor to extract features of the second ground captured image;
inputting the second aerial captured image to a second feature extractor to extract features of the second aerial captured image;
inputting the second map image to a third feature extractor to extract features of the second map image;
computing a second combined loss based on the features of the second ground captured image, the features of the second aerial captured image, and the features of the second map image; and
updating the first feature extractor, the second feature extractor, and the third feature extractor based on the second combined loss.

13. A non-transitory computer-readable storage medium storing a program that causes a computer to execute:
acquiring a training data including a first ground captured image, a first aerial captured image, and a first map image;
inputting the first ground captured image to a first feature extractor to extract features of the first ground captured image;
inputting the first aerial captured image to a second feature extractor to extract features of the first aerial captured image;
inputting the first map image to a third feature extractor to extract features of the first map image;
computing a combined loss based on the features of the first ground captured image, the features of the first aerial captured image, and the features of the first map image; and
updating the first feature extractor, the second feature extractor, and the third feature extractor based on the combined loss.

14. The storage medium according to claim 13,
wherein the computation of the combined loss includes:
computing a first loss based on the features of the first ground captured image and the features of the first aerial captured image;
computing a second loss based on the features of the first ground captured image and the features of the first map image;
computing a third loss based on the features of the first aerial captured image and the features of the first map image; and
combining the first loss, the second loss, and the third loss into the combined loss.

15. The storage medium according to claim 14,
wherein the combined loss is a weighted sum of the first loss, the second loss, and the third loss.

16. The storage medium according to claim 13,
wherein the program causes the computer to further execute:
generating an augmented training data based on the training data, the augmented training data including a second ground captured image, a second aerial captured image, and a second map image,
wherein the generation of the augmented training data includes:
blending a part of the first aerial captured image and a part of the first map image to generate an augmented image; and
replacing the part of the first aerial captured image with the augmented image to obtain the second aerial captured image, replacing the part of the first map image with the augmented image to obtain the second map image, or doing both.

17. The storage medium according to claim 16,
wherein the generation of the augmented training data further includes:
determining one or more partial image pairs each of which is a pair of a part of the first aerial captured image and a part of the first map image; and
generating the augmented image for each partial image pair,
wherein the part of the first aerial captured image and the part of the first map image that are included in a partial image pair have a same position, a same shape, and a same size as each other, and
the determination of the partial image pair includes determining the position, the shape, and the size for the partial image pair.

18. The storage medium according to claim 16,
wherein the program causes the computer to further execute:
inputting the second ground captured image to a first feature extractor to extract features of the second ground captured image;
inputting the second aerial captured image to a second feature extractor to extract features of the second aerial captured image;
inputting the second map image to a third feature extractor to extract features of the second map image;
computing a second combined loss based on the features of the second ground captured image, the features of the second aerial captured image, and the features of the second map image; and
updating the first feature extractor, the second feature extractor, and the third feature extractor based on the second combined loss.
